(19) United States
(12) Patent Application Publication
(10) Pub. No.: US 2023/0103331 A1
(43) Pub. Date: Apr. 6, 2023

(54) CATALYST CONFIGURATION FOR RENEWABLE JET PRODUCTION

(71) Applicant: ExxonMobil Technology and Engineering Company, Annandale, NJ (US)

(72) Inventors: Xiaochun Xu, Basking Ridge, NJ (US); Madelyn M. Evans, Jersey City, NJ (US); Alexander J. Dulin, Haddonfield, NJ (US)

(21) Appl. No.: 17/931,568

(22) Filed: Sep. 13, 2022

Related U.S. Application Data
(60) Provisional application No. 63/261,964, filed on Oct. 1, 2021.

(51) Int. Cl. C10G 47/36; C10G 49/22

(52) U.S. Cl. CPC C10G 47/36; C10G 49/22; C10G 2300/1011; C10G 2300/4081; C10G 2400/08

(57) ABSTRACT

This application relates to methods and systems that utilize catalytic methods to produce jet fuel such as hydrocarbons with carbons numbers from C9 to C16. Disclosed herein is an example method of producing renewable jet fuel. Examples embodiments of the method include hydrocracking a biofeedstock by reaction with hydrogen in the presence of a hydrocracking catalyst to form a hydrocracked biofeedstock. Examples embodiments of the method further include isomerizing at least a portion of the hydrocracked biofeedstock in the presence of a dewaxing catalyst to form a dewaxed effluent. Examples embodiments of the method further include separating the dewaxed effluent to form a renewable jet fuel product.

### CROSS-REFERENCE TO RELATED APPLICATIONS

This application claims the benefit of U.S. Provisional Application No. 63/261,964, filed on Oct. 1, 2021, the entire contents of which are incorporated herein by reference.

### FIELD

This application relates to methods and systems that utilize catalytic processes to produce jet fuel such as hydrocarbons with carbons numbers from C9 to C16.

### BACKGROUND

Aviation is difficult to decarbonize due to the need for energy dense fuel sources. Conventional jet fuels are advantageous as they are readily produced from fractional distillation of crude oil, have high energy density, and are liquid across a broad range of temperatures and pressures. The hydrocarbons in jet fuel are typically mixtures of paraffin, naphthene, and aromatics with carbon numbers from 9 to 16 (C9-C16). Jet fuels are typically formulated with various ratios of isomers of the C9-C16 hydrocarbons to provide the desired distillation properties, freezing point, density, thermal stability, and other physical properties.

While there has been strong interest in the industry to produce a bio-jet fuel derived partially or entirely from renewable resources, there are few natural sources of fatty acid chains that can be used to produce jet fuel within the acceptable C9-C16 carbon range. Commercially available fats and oils are relatively expensive starting materials and any inefficiencies in the process which reduce yield or produce jet fuel without the correct properties are to the detriment of the cost of the final product jet fuel. The presently used catalyst configurations for production of renewable jet fuel may produce renewable jet fuel physical properties that are not always suitable as a drop in replacement for petroleum derived jet fuel.

### SUMMARY

Disclosed herein is an example method of producing renewable jet fuel. Examples embodiments of the method include hydrocracking a biofeedstock by reaction with hydrogen in the presence of a hydrocracking catalyst to form a hydrocracked biofeedstock. Examples embodiments of the method further include isomerizing at least a portion of the hydrocracked biofeedstock in the presence of a dewaxing catalyst to form a dewaxed effluent. Examples embodiments of the method further include separating the dewaxed effluent to form a renewable jet fuel product.

Disclosed herein is an example system for production of renewable jet fuel. Examples embodiments of the system include a hydrocracking stage that receives a biofeedstock and produces a hydrocracked product stream comprising hydrocracked biofeedstock. Examples embodiments of the system further include a dewaxing stage that receives the hydrocracked product stream from the hydrocracking stage and generates a dewaxed product stream. Examples embodiments of the system further include a product separator that receives the dewaxed product stream from the dewaxing stage and separates a renewable jet fuel product.

These and other features and attributes of the discloses methods and systems of the present disclosure and their advantageous applications and/or uses will be apparent from the detailed description which follows.

### BRIEF DESCRIPTION OF THE DRAWINGS

To assist those of ordinary skill in the relevant art in making and using the subject matter hereof, reference is made to the appended drawings, wherein:

FIG. 1 is a block flow diagram of a process for producing jet range hydrocarbons from triglycerides in accordance with one or more embodiments;

FIG. 2 is a schematic illustration of a process for producing jet range hydrocarbons from triglycerides in accordance with one or more embodiments;

FIG. 3 is a schematic illustration of another process for producing jet range hydrocarbons from triglycerides in accordance with one or more embodiments;

FIG. 4 is a schematic illustration of another process for producing jet range hydrocarbons from triglycerides in accordance with one or more embodiments; and

FIG. 5 is a schematic illustration of another process for producing jet range hydrocarbons from triglycerides in accordance with one or more embodiments.

### DETAILED DESCRIPTION

The following is a detailed description of the disclosure provided to aid those skilled in the art in practicing the present disclosure. Those of ordinary skill in the art may make modifications and variations in the embodiments described herein without departing from the spirit or scope of the present disclosure. Unless otherwise defined, all technical and scientific terms used herein have the same meaning as commonly understood by one of ordinary skill in the art to which this disclosure belongs. The terminology used in the description of the disclosure herein is for describing particular embodiments only and is not intended to be limiting of the disclosure.

This application relates to methods and systems for producing jet range hydrocarbons from triglycerides sourced from natural sources. In some embodiments, set range hydrocarbons include paraffins, naphthenes, and aromatics with carbon numbers from 9 to 16 (C9-C16) and isomers thereof. The process described herein is versatile and examples embodiments are suitable for producing jet range hydrocarbons from many different grades and sources of triglycerides. Jet range hydrocarbons produced from renewable bio-derived sources are often termed renewable jet fuel. In some embodiments, a side product of the present process includes renewable naphtha with carbon number from C5-C12, and renewable diesel with carbon number from C13+, which includes, but is not limited to, paraffins, naphthenes and aromatics.

Renewable diesel production is typically carried out in a two-step process whereby a biofeedstock is converted to diesel fuel with carbon numbers ranging from C9-C18. Renewable diesel may be compositionally identical to petroleum derived diesel and may have properties allowing the renewable diesel to be utilized as a drop in replacement for petroleum derived diesel. In some embodiments, a suitable biofeedstock includes triglycerides which typically include three fatty acid chains with carbon chain lengths of C14-C22 bound to glycerol backbone. Canola oil, for example, typically contains a majority fraction of C18 fatty acids with minor components of C16 and C20 fatty acids. The renewable diesel process typically involves hydrotreating the biofeedstock to produce a hydrotreated product. Examples embodiments of the hydrotreatment process converts the triglycerides into the corresponding n-paraffins such as n-C17 and n-C18 for canola oil. Normal paraffins typically have poor cold flow properties so example embodiments include an additional dewaxing step to isomerize the n-paraffins to iso-paraffins or to crack the n-paraffins to shorter chain paraffins. In some embodiments, the hydrotreated product are introduced into a dewaxing stage to convert a portion of the paraffins to the corresponding iso-paraffins and may crack a portion of the relatively longer hydrocarbon chain paraffins to shorter chain paraffins. The dewaxed product from the dewaxing stage includes C9-C16 hydrocarbons with suitable properties to be utilized as jet fuel, in accordance with one or more embodiments.

Jet fuels across all grades and standards typically have lower boiling points than diesel. According to ASTM specification D7566, renewable jet from hydroprocessed esters and fatty acids has a max T10 specification at 205° C. and a final boiling point specification at 300° C. The freezing point specification is specified as −40° C. Biofeedstock derived paraffins such as C17 and C18 paraffins, as well as longer paraffins, do not have the required boiling point for jet fuel. Table 1 shows the boiling point and melting point for normal paraffins from C15 to C18 and it can be observed that both C17 and C18 fall outside of the final boiling point range of jet fuel. Further, the melting point of C15 to C18 fall outside the acceptable freezing point range for jet fuel specification, necessitating isomerization to improve the freezing point. As will be discussed in detail below, different catalyst configurations result in a dewaxed product from the dewaxing stage with differing physical properties.

TABLE 1

| | BP ° C. | MP ° C. |
|---|---|---|
| n-C15 | 270.5 | 10 |
| n-C16 | 286.6 | 18.3 |
| n-C17 | 302.2 | 22.2 |
| n-C18 | 317.2 | 28.3 |

In accordance with one or more embodiments, the process described herein is selective to jet range hydrocarbons which can result in increased yield of jet fuel with required physical properties as compared to previous methods and methods for producing jet range hydrocarbons from triglycerides. Embodiments of the methods described herein include several unit operations including hydrocracking of a biofeedstock to produce a hydrocracked product followed by isomerization of the hydrocracked product to form a renewable jet product. While embodiments of the methods described herein are suitable for use for a variety of triglycerides, the process may be particularly suited for triglycerides which contain fatty acids where the carbon chain is 18 carbons long or longer.

There may be several potential advantages to the methods and systems disclosed herein, only some of which may be alluded to in the present disclosure. As discussed above, current techniques for producing jet range hydrocarbons from triglycerides may be problematic due to their low yields. The process described herein is a scalable process with improved kinetics and selectivity to jet range hydrocarbons without the typical problems associated with low jet range hydrocarbon yield.

In accordance with example embodiments, the renewable jet fuel is produced from a biofeedstock. Any of a variety of suitable biofeedstocks may be used in the production of the renewable jet fuel. Embodiments of the methods and systems described herein include triglyceride as a biofeedstock. Examples of suitable triglycerides include any triglyceride which includes at least one saturated or unsaturated fatty acid molecule with a carbon chain length of at least C9 to C32. Any symmetrical or unsymmetrical triglyceride which meets these constraints may be used in the present process. In some embodiments, the biofeedstock includes hydrocracked triglycerides. In some embodiments, the biofeedstock includes a pyrolysis oil.

The triglyceride may be from any source including an algal source containing at least one saturated or unsaturated fatty acid molecule with a carbon chain length of at least C9 to C32. Algal sources for algae oils can include, but are not limited to, unicellular and multicellular algae. Examples of such algae include a rhodophyte, chlorophyte, heterokontophyte, tribophyte, glaucophyte, chlorarachniophyte, euglenoid, haptophyte, cryptomonad, dinoflagellum, phytoplankton, and the like, and combinations thereof. In one embodiment, algae is of the classes Chlorophyceae and/or Haptophyta. Examples of specific species include, but are not limited to, Neochloris oleoabundans, Scenedesmus dimorphus, Euglena gracilis, Phaeodactylum tricornutum, Pleurochrysis camerae, Prymnesium parvum, Tetraselmis chui, and Chlamydomonas reinhardtii. Additional or alternate algal sources can include one or more microalgae of the Achnanthes, Amphiprora, Amphora, Ankistrodesmus, Asteromonas, Boekelovia, Borodinella, Botryococcus, Bracteococcus, Chaetoceros, Carteria, Chlamydomonas, Chlorococcum, Chlorogonium, Chlorella, Chroomonas, Chrysosphaera, Cricosphaera, Crypthecodinium, Cryptomonas, Cyclotella, Dunaliella, Ellipsoidon, Emiliania, Eremosphaera, Ernodesmius, Euglena, Franceia, Fragilaria, Gloeothamnion, Haematococcus, Halocafeteria, Hymenomonas, Isochrysis, Lepocinclis, Micractinium, Monoraphidium, Nannochloris, Nannochloropsis, Navicula, Neochloris, Nephrochloris, Nephroselmis, Nitzschia, Ochromonas, Oedogonium, Oocystis, Ostreococcus, Pavlova, Parachlorella, Pascheria, Phaeodactylum, Phagus, Platymonas, Pleurochrysis, Pleurococcus, Prototheca, Pseudochlorella, Pyramimonas, Pyrobotrys, Scenedesmus, Skeletonema, Spyrogyra, Stichococcus, Tetraselmis, Thalassiosira, Viridiella, and Volvox species, and/or one or more cyanobacteria of the Agmenellum, Anabaena, Anabaenopsis, Anacystis, Aphanizomenon, Arthrospira, Asterocapsa, Borzia, Calothrix, Chamaesiphon, Chlorogloeopsis, Chroococcidiopsis, Chroococcus, Crinalium, Cyanobacterium, Cyanobium, Cyanocystis, Cyanospira, Cyanothece, Cylindrospermopsis, Cylindrospermum, Dactylococcopsis, Dermocarpella, Fischerella, Fremyella, Geitleria, Geitlerinema, Gloeobacter, Gloeocapsa, Gloeothece, Halospirulina, Iyengariella, Leptolyngbya, Limnothrix, Lyngbya, Microcoleus, Microcystis, Myxosarcina, Nodularia, Nostoc, Nostochopsis, Oscillatoria, Phormidium, Planktothrix, Pleurocapsa, Prochlorococcus, Prochloron, Prochlorothrix, Pseudanabaena, Rivularia, Schizothrix, Scytonema, Spirulina, Stanieria, Starria, Stigonema, Symploca, Synechococcus, Synechocystis, Tolypothrix, Trichodesmium, Tychonema, and Xenococcus species. Alternatively, or in addition to seed and/or plant oils, the triglyceride may be sourced from an algae that is capable of producing triglycerides which include at least at least one saturated or unsaturated fatty acid molecule with a carbon chain length of at least C9 to C32. The algae strain may be selected for its tendency to produce the triglyceride described above or may be genetically engineered to produce triglycerides with the properties suitable for production of jet range hydrocarbons.

Additional examples of the biofeedstock include vegetable oils with at least one saturated or unsaturated fatty acid molecule with a carbon chain length of at least C9 to C32. Examples of vegetable oils that can be used include, but are not limited to rapeseed (canola) oil, soybean oil, coconut oil, sunflower oil, palm oil, palm kernel oil, peanut oil, linseed oil, tall oil, corn oil, castor oil, jatropha oil, jojoba oil, olive oil, flaxseed oil, camelina oil, safflower oil, babassu oil, tallow oil, and rice bran oil. Vegetable oils as referred to herein also include processed vegetable oil material. Non-limiting examples of processed vegetable oil material include fatty acids and fatty acid alkyl esters. Alkyl esters typically include C₁-C₅ alkyl esters. In some embodiments, one or more of methyl, ethyl, and propyl esters are used.

Additional examples of the biofeedstock include animal fats. Examples of animal fats include, but are not limited to, beef fat (tallow), hog fat (lard), turkey fat, fish fat/oil, and chicken fat. The animal fats can be obtained from any suitable source including restaurants and meat production facilities. Animal fats as referred to herein also include processed animal fat material. Non-limiting examples of processed animal fat material include fatty acids and fatty acid alkyl esters. Alkyl esters typically include C₁-C₅ alkyl esters. In some embodiments, one or more of methyl, ethyl, and propyl esters are used.

Additional examples of the biofeedstocks include a waste stream. Non-limiting example of suitable waste streams include used cooking oil and animal fat waste.

Additional examples of the biofeedstock include feedstocks that primarily include triglycerides and free fatty acids (FFAs). The triglycerides and FFAs typically contain aliphatic hydrocarbon chains in their structure having from 8 to 36 carbons, for example, from 10 to 26 carbons or 14 to 22 carbons. Types of triglycerides can be determined according to their fatty acid constituents. The fatty acid constituents can be readily determined using Gas Chromatography (GC) analysis. This analysis involves extracting the fat or oil, saponifying (hydrolyzing) the fat or oil, preparing an alkyl (e.g., methyl) ester of the saponified fat or oil, and determining the type of (methyl) ester using GC analysis. In one embodiment, a majority (i.e., greater than 50%) of the triglyceride present in the lipid material can include C₁₀ to C₂₆ fatty acid constituents, based on total triglyceride present in the lipid material. Further, a triglyceride is a molecule having a structure substantially identical to the reaction product of glycerol and three fatty acids. Thus, although a triglyceride is described herein as being including fatty acids, it should be understood that the fatty acid component does not necessarily contain a carboxylic acid hydrogen. In one embodiment, a majority of triglycerides present in the biocomponent feed can include a carbon chain length of at least C9 to C32, based on total triglyceride content. Other types of feed that are derived from biological raw material components can include fatty acid esters, such as fatty acid alkyl esters (e.g., FAME and/or FAEE).

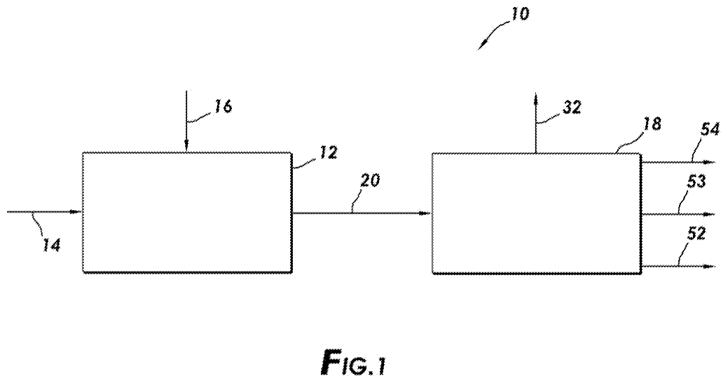

FIG. 1 is a simplified block diagram illustrating a system 10 for renewable jet fuel production in accordance with some embodiments. As illustrated, embodiments of the system 10 include the following stages: (i) a hydrocracking stage 12 in which a biofeedstock stream 14 containing a biofeedstock is reacted with hydrogen from a hydrogen stream 16 to hydrocrack the biofeedstock stream 14; and (ii) a dewaxing stage 18 that receives a hydrocracked biofeedstock stream 20 containing hydrocracked biofeedstock and catalytically dewaxes the hydrocracked biofeedstock to produce a renewable jet fuel product 52 with improved cold flow properties, renewable diesel 53 with improved cold flow properties and renewable naphtha 54. While not shown on FIG. 1, at least a portion of the renewable diesel 53 may be recycled to the hydrocracking stage 12 and/or the dewaxing stage 18. In the illustrated embodiment, the dewaxing stage 18 also generates dewaxing gas stream 32 which contains, for example, hydrogen and other gases generated in the dewaxing stage 18. To maximize jet yield, for example, renewable diesel 53 may be fully or partially recycled back to hydrocracking stage or dewaxing stage for further conversion to renewable jet product.

In accordance with one or more embodiments, the hydrocracking stage 12 includes a hydrocracking catalyst. In some embodiments, the hydrocracking catalyst serves a dual function as having both hydrogenation and cracking sites to break longer carbon chains to shorter carbon chains and/or to remove hetero atoms and selectively saturate olefins. Hydrocracking catalysts typically include a Group VIII and Group VIB metal hydrogenating component on a zeolite cracking or amorphous silica aluminate or alumina base. The zeolite cracking bases may include molecular sieves, and are generally composed of silica, alumina, and one or more exchangeable cations such as sodium, magnesium, calcium, and/or rare earth metals. Examples of molecular sieves suitable for the present process include crystal pores of relatively uniform diameter between 4 and 50 Angstroms. In some embodiments, the molecular sieves include zeolites such as mordenite, clinoptiliolite, ferrierite, dachiardite, chabazite, erionite, faujasite, Beta, X, Y, L, ZSM-5, ZSM-48, ZSM-23, ZSM-11 and MCM-22, for example. Non-limiting examples of metals for the hydrocracking catalysts include iron, cobalt, nickel, molybdenum, tungsten, ruthenium, rhodium, palladium, osmium, iridium, and platinum, and combination thereof. The hydrocracking catalyst may include metal in any suitable amount such as from 0.05 wt. % to 30 wt. %, based on the total weight of the catalyst. In some embodiments, the hydrocracking catalyst includes metal in an amount of 0.3 wt. % or more, 0.5 wt. % or more, 1.0 wt. % or more, 2.0 wt. % or more, 2.5 wt. % or more, 3.0 wt. % or more, or 5.0 wt. % or more.

In accordance with one or more embodiments, hydrocracking is performed by exposing the biofeedstock and hydrogen to a hydrocracking catalyst under effective hydrocracking conditions. Examples of effective hydrocracking conditions include, but are not limited to, temperatures from 200° to 425° C., from 220° to 330° C., from 245° to 315° C., or from 260° C. to 285° C. Additional examples of effective hydrocracking conditions include, but are not limited to, a pressure of 1.3 MPag to 30 Mpag, 1.3 MPag to 5 MPag, 5 MPag to 10 MPag, 10 MPag to 20 MPag, or 20 MPag to 30 MPag. Additional examples of hydrocracking conditions include, but are not limited to, liquid hourly space velocity from 0.2 to 10 V/V/Hr, 1 to 5 V/V/Hr, or 5 to 10 V/V/Hr.

In the dewaxing stage 18, at least a portion of the hydrocracked biofeedstock in the hydrocracked biofeedstock stream 20 is catalytically dewaxed, in one or more embodiments, to produce a renewable jet fuel product 52 with improved cold flow properties, such as freezing point. Catalytic dewaxing relates to the removal and/or isomerization of long chain paraffinic molecules from the hydrocracked biofeedstock. In some embodiments, catalytic dewaxing is accomplished by selective hydrocracking or by hydroisomerization of these long chain molecules. Hydroisomerization is preferred to minimize yield loss to light products. In addition to renewable jet fuel product 52, in the illustrated embodiment, dewaxing gas stream 32 also exits the dewaxing stage 18. The dewaxing gas stream 32 contains, for example, hydrogen and other gases generated in the dewaxing stage 18.

In accordance with one or more embodiments, the dewaxing stage 18 includes a dewaxing catalyst. In some embodiments, the dewaxing catalyst includes molecular sieves such as crystalline aluminosilicates (zeolites) and/or silicoaluminophosphates (SAPOs). For example, the molecular sieve can be a 1-D or 3-D molecular sieve. By way of further example, the molecular sieve can be a 10-member ring 1-D molecular sieve (e.g., ZSM-48). Examples of molecular sieves can include, but are not limited to, ZSM-48, ZSM-23, ZSM-35, Beta, USY, ZSM-5, and combinations thereof. In an embodiment, the molecular sieve can include or be ZSM-48, ZSM-23, or a combination thereof. The dewaxing catalyst can optionally include a binder, such as alumina, titania, silica, silica-alumina, zirconia, or a combination thereof. In an embodiment, the binder can include or be alumina, titania, or a combination thereof. In another embodiment, the binder can include or be titania, silica, zirconia, or a combination thereof.

In some embodiments, the dewaxing catalyst also includes a metal hydrogenation component, such as a Group VIII metal. Suitable Group VIII metals can include, but are not limited to, Pt, Pd, Ni, and combinations thereof. In some embodiments, the dewaxing catalyst includes 0.1 wt. % or more of the Group VIII metal, for example, 0.3 wt. % or more, 0.5 wt. % or more, 1.0 wt. % or more, 2.0 wt. % or more, 2.5 wt. % or more, 3.0 wt. % or more, or 5.0 wt. % or more. Additionally or alternately, the dewaxing catalyst can include 10.0 wt. % or less of a Group VIII metal, for example 7.0 wt. % or less, 5.0 wt. % or less, 3.0 wt. % or less, 2.5 wt. % or less, 2.0 wt. % or less, or 1.5 wt. % or less.

In some embodiments, particularly when Group VIII metal is a non-noble metal such as Ni, the dewaxing catalyst may additionally include a Group VIB metal, such as W and/or Mo. For instance, in one embodiment, the dewaxing catalyst can include Ni and W, Ni and Mo, or a combination of Ni, Mo, and W. In certain such embodiments, the dewaxing catalyst can include 0.5 wt. % or more of the Group VIB metal, for example, 1.0 wt. % or more, 2.0 wt. % or more, 2.5 wt. % or more, 3.0 wt. % or more, 4.0 wt. % or more, or 5.0 wt. % or more. Additionally or alternately, the dewaxing catalyst can include 20.0 wt. % or less of a Group VIB metal, for example 15.0 wt. % or less, 12.0 wt. % or less, 10.0 wt. % or less, 8.0 wt. % or less, 5.0 wt. % or less, 3.0 wt. % or less, or 1.0 wt. % or less. In one particular embodiment, the dewaxing catalyst can include only a Group VIII metal selected from Pt, Pd, and a combination thereof.

Catalytic dewaxing can be performed by exposing the hydrocracked biofeedstock stream 20 to a dewaxing catalyst (that may, and usually does, also have isomerization activity) under effective (catalytic) dewaxing (and/or isomerization) conditions. Effective dewaxing conditions can include, but are not limited to, a temperature of 500° F. (260° C.) or higher, for example, bout 550° F. (288° C.) or higher, 600° F. (316° C.) or higher, or 650° F. (343° C.) or higher. Additionally, or alternately, the temperature can be 750° F. (399° C.) or less, for example 700° F. (371° C.) or less, or 650° F. (343° C.) or less. Effective dewaxing conditions can additionally or alternately include, but are not limited to, a total pressure of 1.3 MPag or more, for example, 1.7 Mpag or more, 3.4 MPag or more, 5.2 MPag or more, or 6.9 MPag or more. Additionally or alternately, the total pressure can be 10.3 MPag or less, for example 8.2 MPag or less, 6.9 MPag or less, or 5.5 MPag or less.

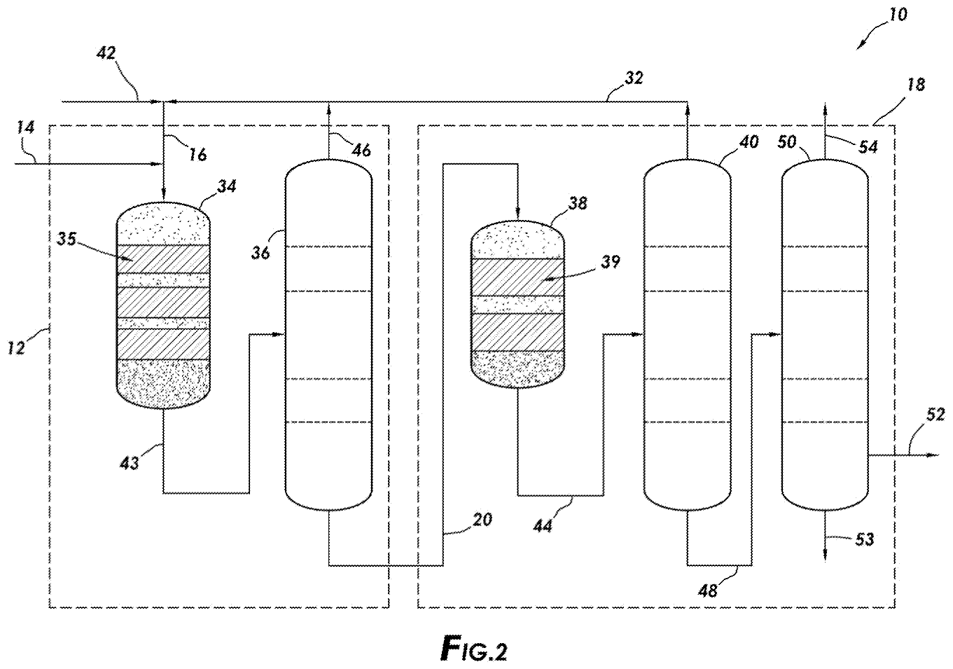

FIG. 2 illustrates an example of the system 10 for renewable jet fuel production in accordance with some embodiments. In the illustrated embodiments, the system 10 includes the hydrocracking stage 12 and the dewaxing stage 18. In some embodiments, the hydrocracking stage 12 includes a hydrocracking reactor 34 and a hydrocracking separator 36. As illustrated, the dewaxing stage 18 includes, for example, a dewaxing reactor 38, a dewaxing separator 40, and a product separator 50. In some embodiments, a biofeedstock stream 14 comprising a biofeedstock and a hydrogen stream 16 comprising hydrogen can be combined and introduced into the hydrocracking reactor 34. However, it should be understood that these streams may alternatively be separately introduced to the hydrocracking reactor 34. In the hydrocracking reactor 34, the biofeedstock and hydrogen react, in accordance with one or more embodiments, in the presence of a hydrocracking catalyst 35 to produce a hydrocracking reactor effluent stream 43. The hydrotreatment in the hydrocracking reactor 34 is discussed in the preceding sections. In the illustrated embodiments, the hydrocracking reactor effluent stream 43 flows from the hydrocracking reactor 34 into a hydrocracking separator 36 for separation of the gas-phase products from the liquid-phase products. In some embodiments, the liquid-phase products comprising hydrocracked biofeedstock is withdrawn from the hydrocracking separator 36 as hydrocracked biofeedstock stream 20. In some embodiments, the gas-phase products are withdrawn from the hydrocracking separator 36 as hydrocracked gas recycle stream 46. As illustrated, the hydrocracked gas recycle stream 46 may be combined with the dewaxing gas stream 32 from the dewaxing separator 40 to form the hydrogen stream 16 fed to the hydrocracking reactor 34. Makeup hydrogen stream 42 may also be combined into the hydrogen stream 16 as needed.

In the illustrated embodiment, the hydrocracked biofeedstock stream 20 comprising hydrocracked biofeedstock is introduced into the dewaxing stage 18. For example, the hydrocracked biofeedstock stream 20 is introduced into dewaxing reactor 38. In the dewaxing stage 18, the hydrocracked biofeedstock reacts, in accordance with one or more embodiments, in the presence of a dewaxing catalyst 39 to form a dewaxing reactor effluent 44. The dewaxing that occurs in the dewaxing reactor 38 is discussed in the preceding sections. Embodiments include introduction of the dewaxing reactor effluent 44 into a dewaxing separator 40 for separation of the gas-phase products from the liquid-phase products. In the illustrated embodiment, the gas-phase products are withdrawn from the dewaxing ‘separator 40 as dewaxing gas stream 32 and combined with the hydrocracked gas recycle stream 46 for recycle to the hydrocracking reactor 34. In the illustrated embodiments, the liquid-phase products are withdrawn from the dewaxing separator 40 as dewaxing separator bottoms 48 which are then introduced into product separator 50, for example. Although shown as one unit, product separator 50 may include several unit operations such as steam stripping, distillation, and quenching, for example, to separate the renewable naphtha portion from the renewable jet fuel portion of dewaxing separator bottoms 48. In the illustrated embodiments, renewable naphtha 54, renewable diesel 53, and renewable jet fuel product 52 are withdrawn from product separator 50. While not shown on FIG. 2, at least a portion of the renewable diesel 53 may be recycled to the hydrocracking reactor 34 and/or the dewaxing reactor 38.

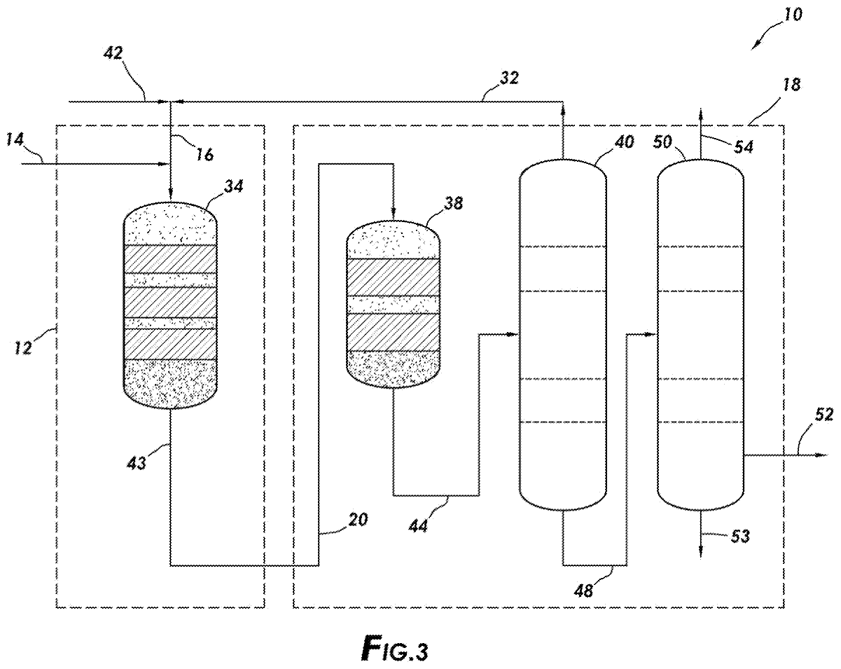

FIG. 3 illustrates another example of the system 10 for renewable jet fuel production in accordance with some embodiments. As illustrated, embodiments of the system 10 include the hydrocracking stage 12 and the dewaxing stage 18. In contrast to the embodiment shown on FIG. 2, the illustrated embodiment does not include a separator (e.g., hydrocracking separator 36 on FIG. 2) between the hydrocracking stage 12 and the dewaxing stage 18. In the illustrated embodiment, the biofeedstock stream 14 comprising biofeedstock and the hydrogen stream 16 comprising hydrogen is combined and introduced into the hydrocracking reactor 34. However, it should be understood that these streams may alternatively be separately introduced to the hydrocracking reactor 34. In the hydrocracking reactor 34, the biofeedstock and hydrogen react, in accordance with one or more embodiments, in the presence of a hydrocracking catalyst 35 to produce a hydrocracking reactor effluent stream 43. The hydrotreatment in the hydrocracking reactor 34 is discussed in the preceding sections. In the illustrated embodiment, the hydrocracking reactor effluent stream 43 comprising hydrocracked biofeedstock flows from the hydrocracking reactor 34 and be introduced into the dewaxing stage 18. For example, the hydrocracked biofeedstock stream 20 is flowed from the hydrocracking reactor 34 to the dewaxing reactor 38 without intervening separation. In the dewaxing stage 18, the hydrocracking biofeedstock reacts, in accordance with one or more embodiments, in the presence of a dewaxing catalyst 39 to form a dewaxing reactor effluent 44. The dewaxing that occurs in the dewaxing reactor 38 is discussed in the preceding sections. In the illustrated embodiment, the dewaxing reactor effluent 44 is introduced into a dewaxing separator 40 for separation of the gas-phase products from the liquid-phase products. In the illustrated embodiments, the gas-phase products are withdrawn from the dewaxing separator 40 as dewaxing gas stream 32 and combined with makeup hydrogen stream 42, for example, for recycle to the hydrocracking reactor 34. In the illustrated embodiment, the liquid-phase products are withdrawn from the dewaxing separator 40 as dewaxing separator bottoms 48 which is introduced into product separator 50, for example. Although shown as one unit, product separator 50 may include several unit operations such as steam stripping, distillation, and quenching, for example, to separate the renewable naphtha portion from the renewable jet fuel portion of dewaxing separator bottoms 48. In some embodiments, renewable naphtha 54, renewable diesel 53, and renewable jet fuel product 52 are withdrawn from product separator 50. While not shown on FIG. 3, at least a portion of the renewable diesel 53 may be recycled to the hydrocracking reactor 34 and/or the dewaxing reactor 38.

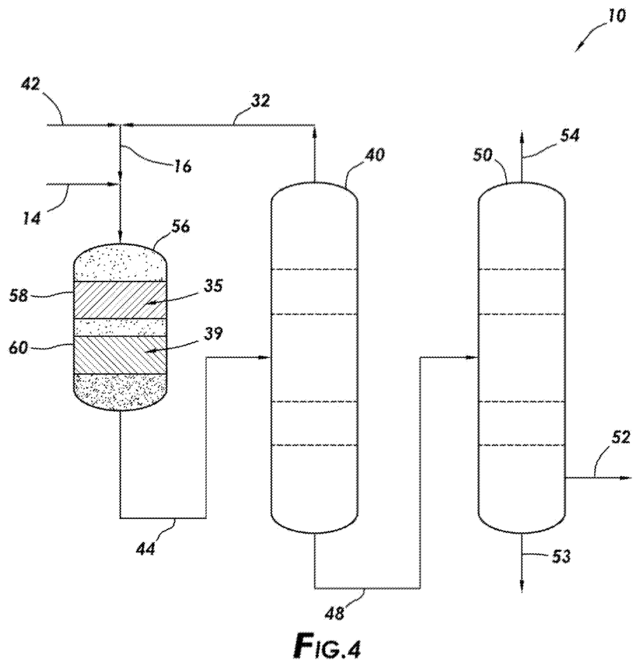

FIG. 4 illustrates another example of the system 10 for renewable jet fuel production in accordance with some embodiments. As illustrated, embodiments of the system 10 include a common reactor 56 with the hydrocracking catalyst 35 and the dewaxing catalyst 39. In contrast to the embodiments shown on FIGS. 2 and 3, the illustrated embodiment includes integration of the hydrocracking and dewaxing into the common reactor 56. In the illustrated embodiment, the common reactor 56 includes both the hydrocracking catalyst 35 and the dewaxing catalyst 39 in hydrocracking catalyst bed 58 and dewaxing catalyst bed 60, respectively. As illustrated, the embodiments of the dewaxing catalyst 39 in the dewaxing catalyst bed 60 are stacked after the hydrocracking catalyst 35 in the dewaxing catalyst bed 60. In the illustrated embodiments, the biofeedstock stream 14 comprising biofeedstock and the hydrogen stream 16 comprising hydrogen are combined and introduced into the common reactor 56. However, it should be understood that these streams may alternatively be separately introduced to the common reactor 56. In the common reactor 56 the biofeedstock and the hydrogen react, in accordance with one or more embodiments, in the presence of a hydrocracking catalyst 35 to produce reaction products that further react in the presence of the dewaxing catalyst 39. In the illustrated embodiment, the dewaxing reactor effluent 44 is withdrawn from the common reactor 56 and introduced into a dewaxing separator 40 for separation of the gas-phase products from the liquid-phase products. In the illustrated embodiment, the gas-phase products are withdrawn from the dewaxing separator 40 as dewaxing gas stream 32 and combined with makeup hydrogen stream 42, for example, for recycle to the hydrocracking reactor 34. In the illustrated embodiment, the liquid-phase products are withdrawn from the dewaxing separator 40 as dewaxing separator bottoms 48 which are introduced, for example, into product separator 50. Although shown as one unit, product separator 50 may include several unit operations such as steam stripping, distillation, and quenching, for example, to separate the renewable naphtha portion from the renewable jet fuel portion of dewaxing separator bottoms 48. In some embodiments, renewable naphtha 54, renewable diesel 53, and renewable jet fuel product 52 are withdrawn from product separator 50. While not shown on FIG. 4, at least a portion of the renewable diesel 53 may be recycled to the common reactor 56.

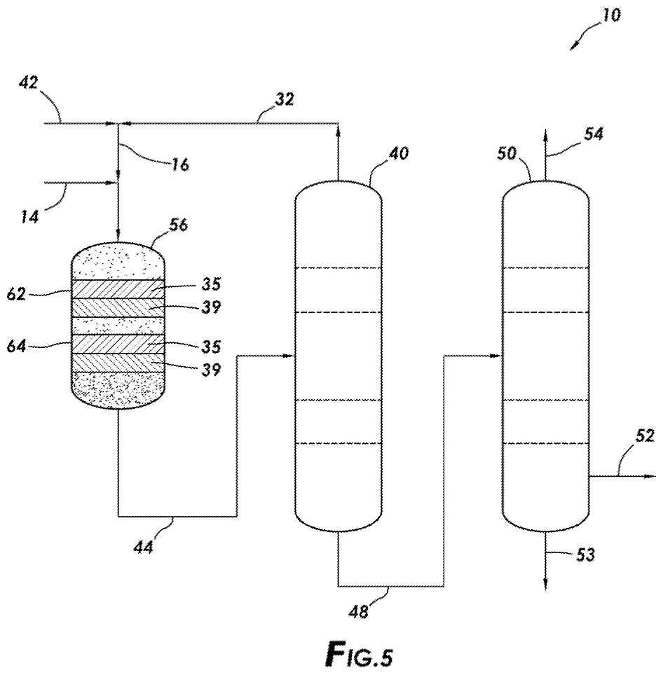

FIG. 5 illustrates another example of the system 10 for renewable jet fuel production in accordance with some embodiments. As illustrated, embodiments of the system 10 include a common reactor 56 with the hydrocracking catalyst 35 and the dewaxing catalyst 39. In contrast to the embodiments shown on FIG. 4, the hydrocracking catalyst 35 and dewaxing catalyst 39 are in the same catalyst beds, e.g., first catalyst bed 62 and second catalyst bed 64. In the illustrated embodiment, the common reactor 56 includes the first catalyst bed 62 containing both hydrocracking catalyst 35 and the dewaxing catalyst 39. In some embodiments, the common reactor 56 further includes the second catalyst bed 64 containing both the hydrocracking catalyst 35 and the dewaxing catalyst 39. As illustrated, embodiments of the dewaxing catalyst 39 in the first and second catalyst beds 62, 64 are stacked after the hydrocracking catalyst 35. In the illustrated embodiment, the biofeedstock stream 14 comprising biofeedstock and the hydrogen stream 16 comprising hydrogen are combined and introduced into the common reactor 56. However, it should be understood that these streams may alternatively be separately introduced to the common reactor 56. In the common reactor 56 the biofeedstock and the hydrogen react, in accordance with one or more embodiments, in the presence of a hydrocracking catalyst 35 to produce reaction products that further react, in accordance with one or more embodiments, in the presence of the dewaxing catalyst 39. In the illustrated embodiments, the dewaxing reactor effluent 44 is withdrawn from the common reactor 56 and introduced into a dewaxing separator 40 for separation of the gas-phase products from the liquid-phase products. In the illustrated embodiment, the gas-phase products are withdrawn from the dewaxing separator 40 as dewaxing gas stream 32 and combined with makeup hydrogen stream 42, for example, for recycle to the hydrocracking reactor 34. In the illustrated embodiment, the liquid-phase products are withdrawn from the dewaxing separator 40 as dewaxing separator bottoms 48 which are introduced, for example, into product separator 50. Although shown as one unit, product separator 50 may include several unit operations such as steam stripping, distillation, and quenching, for example, to separate the renewable naphtha portion from the renewable jet fuel portion of dewaxing separator bottoms 48. In some embodiments, renewable naphtha 54, renewable diesel 53, and renewable jet fuel product 52 are withdrawn from product separator 50. While not shown on FIG. 4, at least a portion of the renewable diesel 53 may be recycled to the common reactor 56.

### Additional Embodiments

Accordingly, the preceding description describes methods and systems for producing jet range hydrocarbons from triglycerides sourced from natural sources including triglycerides. The methods and systems disclosed herein may include any of the various features disclosed herein, including one or more of the following embodiments.

Embodiment 1. A method of producing renewable jet fuel comprising: hydrocracking a biofeedstock by reaction with hydrogen in the presence of a hydrocracking catalyst to form a hydrocracked biofeedstock; isomerizing at least a portion of the hydrocracked biofeedstock in the presence of a dewaxing catalyst to form a dewaxed effluent; and separating the dewaxed effluent to form a renewable jet fuel product.

Embodiment 2. The method of Embodiment 1, wherein the biofeedstock comprises a vegetable oil, an animal fat, a fish oil, a pyrolysis oil, algae lipid, an algae oil, and combinations thereof.

Embodiment 3. The method of Embodiment 1 or Embodiment 2, wherein the biofeedstock comprises lipid compounds.

Embodiment 4. The method of any one of Embodiments 1-3, wherein the biofeedstock comprises a triglyceride comprising a fatty acid molecule with a carbon chain length of 9 carbons to 32 carbons.

Embodiment 5. The method of any one of Embodiments 1-4, wherein the biofeedstock comprises hydrocracked triglycerides.

Embodiment 6. The method of any one of Embodiments 1-5, wherein the hydrocracked biofeedstock comprises paraffins with carbon numbers from C9-C16.

Embodiment 7. The method of any one of Embodiments 1-6, wherein the hydrocracking catalyst is in a hydrocracking reactor.

Embodiment 8. The method of Embodiment 7, wherein the dewaxing catalyst is in a dewaxing reactor.

Embodiment 9. The method of Embodiment 8, wherein the method further comprising flowing a hydrocracking reactor effluent from the hydrocracking reactor to the dewaxing reactor without intervening separation of the hydrocracking reactor effluent.

Embodiment 10. The method of any one of Embodiments 1-9, wherein the renewable jet fuel product comprises at least one of paraffins, naphthenes, or aromatics with carbon numbers from C9 to —C16 or isomers thereof.

Embodiment 11. The method of any one of Embodiments 1-10, wherein the separating the dewaxed effluent further comprises forming a renewable naphtha.

Embodiment 12. The method of Embodiment 11, wherein the renewable naphtha comprises paraffins with carbon numbers from C5 to C12 or isomers thereof.

Embodiment 13. The method of any one of Embodiments 1-12, wherein the separating the dewaxed effluent comprises a renewable diesel.

Embodiment 14. The method of Embodiment 13, wherein at least a portion of the renewable diesel is recycled back to hydrocracking stage or dewaxing stage.

Embodiment 15. The method of any one of Embodiments 1-14, wherein the hydrocracking catalyst and the dewaxing catalyst are included in a common reactor, wherein at least a portion of the dewaxing catalyst is stacked in one or more dewaxing catalyst beds after one or more hydrocracking catalyst beds of the hydrocracking catalyst.

Embodiment 16. The method of any one of Embodiments 1-14, wherein the hydrocracking catalyst and the dewaxing catalyst are included in a common reactor, wherein at least a portion of the dewaxing catalyst is included in a first catalyst bed with the hydrocracking catalyst with the dewaxing catalyst stacked in the first catalyst bed after the hydrocracking catalyst.

Embodiment 17. A system for production of renewable jet fuel comprising: a hydrocracking stage that receives a biofeedstock and produces a hydrocracked product stream comprising hydrocracked biofeedstock; a dewaxing stage that receives the hydrocracked product stream from the hydrocracking stage and generates a dewaxed product stream; and a product separator that receives the dewaxed product stream from the dewaxing stage and separates a renewable jet fuel product.

Embodiment 18. The system of Embodiment 17, wherein the biofeedstock comprises a vegetable oil, an animal fat, a fish oil, a pyrolysis oil, algae lipid, an algae oil, and combinations thereof.

Embodiment 19. The system of Embodiment 17 or Embodiment 18, wherein the hydrocracking stage comprises a hydrocracking reactor.

Embodiment 20. The system of Embodiment 19, wherein the hydrocracking reactor comprises a hydrocracking catalyst.

Embodiment 21. The system of any one of Embodiments 17-20, wherein the dewaxing stage comprises a dewaxing reactor.

Embodiment 22. The system of Embodiment 21, wherein the dewaxing reactor comprises a dewaxing catalyst.

### EXAMPLES

To facilitate a better understanding of the present disclosure, the following examples of certain aspects of some embodiments are given. In no way should the following examples be read to limit, or define, the entire scope of the disclosure.

### Example 1

Three catalyst systems were tested in a pilot plant utilizing octadecane (n-C18) as a feed. The catalyst systems were hydrocracking (HDC) alone, hydrocracking (HDC) followed by isomerization (ISOM) also referred to as dewaxing, and isomerization followed by hydrocracking (HDC). The conditions of each test are shown in Table 2 where LHSV is liquid hourly space velocity and scfb is standard cubic feet of hydrogen per barrel of feed. The cloud point of the liquid product was used as an indication of cold flow performance.

TABLE 2

| | Unit | HDC | HDC/ISOM | ISOM/HDC |
|---|---|---|---|---|
| HDC Catalyst | vol % | 100 | 67 | 67 |
| ISOM Catalyst | vol % | 0 | 33 | 33 |
| Pressure | barg | 68.94 | 68.94 | 68.94 |
| LHSV | 1/h | 2 | 2 | 2 |
| Temperature | ° C. | 320 | 330 | 325 |
| TGR | scfb | 2000 | 2000 | 2000 |
| 300° C. Conversion | wt % | 67 | 69 | 65 |
| Cloud Point | ° C. | −4 | −37 | −6 |

It was observed that at approximately 70% conversion the cloud point was −4° C. for hydrocracking catalyst alone. When the isomerization catalyst was stacked before the hydrocracking catalyst, the cloud point was observed to be improved to −6° C. at 65% conversion. When the isomerization catalyst was stacked after the hydrocracking catalyst, the cloud point was significantly improved to −37° C. at 69% conversion. It was overserved that the hydrocracking followed by isomerization provided superior cloud point reduction as compared to the other tested catalyst configurations.

### Example 2

A second test was performed utilizing a mixture of n-C15, n-C16, n-C17 and n-C18 as a feed. The test conditions are shown in Table 3. It was observed that when isomerization catalyst was stacked after the hydrocracking catalyst, the freezing point was significantly improved. As illustrated in Table 3 below, the fraction with a cut point of 250-572° F. (121-300° C.) can easily meet the freezing point specification of −40° C. For hydrocracking catalyst only, the fraction with a cut point of 250-572 F (121-300° C.) has a freezing point of −28° C. and cannot meet the freezing point specification. In order to meet the freezing specification, component that is heavier than 550° F. (288° C.) has to be cut out, and jet fuel yield is significantly decreased.

TABLE 3

| | | | |
|---|---|---|---|
| HDC Catalyst | vol % | 100 | 67 |
| HDC LHSV | 1/h | 2 | 2 |
| ISOM Catalyst | vol % | — | 33 |
| ISOM LHSV | 1/h | — | 4 |
| 300° C. Conversion | wt % | 73 | 79 |
| Jet (250-572° F.) Freezing Point | ° C. | −28 | −52 |
| Jet (250-572° F.) yield | wt % | 55 | 57 |
| Jet (250-550° F.) Freezing Point | ° C. | −41 | |
| Jet (250-550° F.) yield | wt % | 41 | |

While the disclosure has been described with respect to a number of embodiments and examples, those skilled in the art, having benefit of this disclosure, will appreciate that other embodiments can be devised which do not depart from the scope and spirit of the disclosure as disclosed herein. Although individual embodiments are discussed, the present disclosure covers all combinations of all those embodiments.

While compositions, methods, and processes are described herein in terms of “comprising,” “containing,” “having,” or “including” various components or steps, the compositions and methods can also “consist essentially of or” consist of the various components and steps. The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the disclosure, additionally, they do not exclude impurities and variances normally associated with the elements and materials used.

All numerical values within the detailed description herein are modified by “about” the indicated value, and take into account experimental error and variations that would be expected by a person having ordinary skill in the art

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited.

What is claimed is:

1. A method of producing renewable jet fuel comprising:
hydrocracking a biofeedstock by reaction with hydrogen in the presence of a hydrocracking catalyst to form a hydrocracked biofeedstock;
isomerizing at least a portion of the hydrocracked biofeedstock in the presence of a dewaxing catalyst to form a dewaxed effluent; and
separating the dewaxed effluent to form a renewable jet fuel product.

2. The method of claim 1, wherein the biofeedstock comprises a vegetable oil, an animal fat, a fish oil, a pyrolysis oil, algae lipid, an algae oil, and combinations thereof.

3. The method of claim 1, wherein the biofeedstock comprises lipid compounds.

4. The method of claim 1, wherein the biofeedstock comprises a triglyceride comprising a fatty acid molecule with a carbon chain length of 9 carbons to 32 carbons.

5. The method of claim 1, wherein the biofeedstock comprises hydrocracked triglycerides.

6. The method of claim 1, wherein the hydrocracked biofeedstock comprises paraffins with carbon numbers from C9-C16.

7. The method of claim 1, wherein the hydrocracking catalyst is in a hydrocracking reactor.

8. The method of claim 7, wherein the dewaxing catalyst is in a dewaxing reactor.

9. The method of claim 8, wherein the method further comprising flowing a hydrocracking reactor effluent from the hydrocracking reactor to the dewaxing reactor without intervening separation of the hydrocracking reactor effluent.

10. The method of claim 1, wherein the renewable jet fuel product comprises at least one of paraffins, naphthenes, or aromatics with carbon numbers from C9 to —C16 or isomers thereof.

11. The method of claim 1, wherein the separating the dewaxed effluent further comprises forming a renewable naphtha.

12. The method of claim 11, wherein the renewable naphtha comprises paraffins with carbon numbers from C5 to C12 or isomers thereof.

13. The method of claim 1, wherein the separating the dewaxed effluent comprises a renewable diesel.

14. The method of claim 13, wherein at least a portion of the renewable diesel is recycled back to hydrocracking stage or dewaxing stage.

15. The method of claim 1, wherein the hydrocracking catalyst and the dewaxing catalyst are included in a common reactor, wherein at least a portion of the dewaxing catalyst is stacked in one or more dewaxing catalyst beds after one or more hydrocracking catalyst beds of the hydrocracking catalyst.

16. The method of claim 1, wherein the hydrocracking catalyst and the dewaxing catalyst are included in a common reactor, wherein at least a portion of the dewaxing catalyst is included in a first catalyst bed with the hydrocracking catalyst with the dewaxing catalyst stacked in the first catalyst bed after the hydrocracking catalyst.

17. A system for production of renewable jet fuel comprising:
a hydrocracking stage that receives a biofeedstock and produces a hydrocracked product stream comprising hydrocracked biofeedstock;
a dewaxing stage that receives the hydrocracked product stream from the hydrocracking stage and generates a dewaxed product stream; and
a product separator that receives the dewaxed product stream from the dewaxing stage and separates a renewable jet fuel product.

18. The system of claim 17, wherein the biofeedstock a vegetable oil, an animal fat, a fish oil, a pyrolysis oil, algae lipid, an algae oil, and combinations thereof.

19. The system of claim 17, wherein the hydrocracking stage comprises a hydrocracking reactor.

20. The system of claim 19, wherein the hydrocracking reactor comprises a hydrocracking catalyst.

21. The system of claim 17, wherein the dewaxing stage comprises a dewaxing reactor.

22. The system of claim 21, wherein the dewaxing reactor comprises a dewaxing catalyst.
